(19) United States
(12) Patent Application Publication
(10) Pub. No.: US 2004/0141210 A1
(43) Pub. Date: Jul. 22, 2004

(54) Method and apparatus for halftone image embedding

(76) Inventor: Ping Wah Wong, Sunnyvale, CA (US)

Correspondence Address: Ping Wah Wong, 1443 Knowlton Drive, Sunnyvale, CA, 94087, US

(21) Appl. No.: 10/349,059

(22) Filed: Jan. 22, 2003

(51) Int. Cl. G06K 15/02; H04N 1/405; G09C 5/00

(52) U.S. Cl. 358/3.28; 358/3.06; 358/3.03; 380/54

(57) ABSTRACT

A method to embed a first halftone image into a second halftone image is described. The method includes the steps of (1) generating a first halftone image from a first continuous tone image, (2) placing a collection of halftone pixels from the first halftone image into a second halftone image, where the remaining pixels of the second halftone image are not yet determined, (3) generating the remaining pixels of the second halftone image from a second continuous tone image. The method generates a composite halftone image that contains both halftones of the first and second continuous tone images. The composite image appears visually as the halftone of the second continuous tone image. When the pixels corresponding to the first halftone is extracted and arranged, the second halftone becomes visible. The extraction method can also require the use of a key. The composite image can be used for authentication, ownership assertion, and finger printing purposes for printed documents.

### BACKGROUND OF THE INVENTION

1. Field of the Invention

This invention relates to methods for embedding a first halftone image into a second halftone image.

2. Background Description

The art of embedding information or data into a halftone image has been considered by several authors and inventors. The halftone image embedding problem can be described as follows. A first continuous tone image (the payload) is halftoned into a first halftone image. A collection of pixels of the first halftone image is placed into a second halftone image, with the remaining pixels in the second halftone image undetermined at this moment. A second continuous tone image (the carrier) is then halftoned into the remaining pixels of the second halftone image. After the second halftoning step, the final result is the composite image. The composite image appears visually to an observer as the halftone of the second continuous tone image. When an appropriate procedure is performed on the composite image to extract the pixels of the first halftone image, the first halftone image can then be viewed. In this problem, the first halftone image can be interpreted as the information or the signal that is embedded into the second halftone image.

Digital printers are limited bit depth devices that can produce only a limited number of raw graylevels. For example, a two-level monochrome printer will only be able to print black and white pixels. To print intermediate graylevels, it is necessary to use a halftoning procedure to convert a continuous tone image into a binary halftone image. For printers that can support multiple raw graylevels, e.g. 4 raw graylevels, a corresponding multi-tone procedure can be applied. Halftoning is a procedure that uses the spatial arrangement of black and white dots to represent gray. The halftone image embedding problem is important because this provides a way for information to be embedded into printed images for ownership assertion, authentication, finger printing, and many other purposes. For example, document authentication can be performed if it can be shown that a piece of information can be retrieved from the document, and the owner of the document is the only entity that possesses a digital key for inserting the particular piece of information into the document.

U.S. Pat. No. 5,488,664 teaches a method to embed a binary image (e.g. the logo of an organization) into two halftone images. When each of the two halftone images is viewed individually, the logo cannot be observed. However, when the two binary images are superimposed together, the logo appears and can be observed visually. The method of generating the two halftone images with the aforementioned property is commonly referred to as a conjugate halftoning method. This class of methods relies on the correlation of dots built into the two halftones. U.S. Pat. No. 5,790,703 and U.S. Pat. No. 5,734,752, U.S. patent application US20020106102, and other publications describe different methods for generating conjugate halftone images.

The conjugate halftoning method requires the generation of two halftone images for the same carrier image. These two halftone images are related in a way to permit the embedded information to show when the two halftones are superimposed together. In the extraction of the embedded information, a user must have in possession both copies of the halftone image. Furthermore, the resolution of the image (e.g. a sign or a logo) that is embedded using conjugate halftoning methods is relatively low. We have so far not seen an example of a conjugate halftoning method that demonstrates the embedding of high resolution photographic images.

There is a need for a method to embed a halftone image into another halftone image so that the embedded information can be extracted by a very simple procedure from a single composite image, that the payload image can be any photographic image or graphics, and that the method is secure both from the view point of resistance to attack, and from the view point that it is difficult for an unauthorized user to discover the embedded information in the composite image.

### SUMMARY OF THE INVENTION

This invention provides a method to embed a first halftone of a first continuous tone image (payload image) into a second halftone of a second continuous tone image (carrier image), resulting in a single composite halftone image. The composite halftone image appears visually as a halftone of the carrier image. When appropriate operations are performed to extract a subset of binary pixels from the composite halftone image, the halftone of the first continuous tone image can be viewed. In a preferred embodiment, the system uses a multi-resolution error diffusion algorithm to generate the composite halftone image.

The present invention teaches a method to generate the single composite halftone image. The information in the embedded halftone is extracted using a very simple mechanism of selecting the appropriate pixels from the composite halftone. An advantage of this method is that the composite image is self contained. In other words, extraction of the embedded information only requires a single halftone image, not two halftone images as in some other methods. A second advantage of this method is that the number of halftone pixels in the composite image is the same as the number of pixels in a halftone of the carrier image. That is, the number of halftone pixels is not increased because of the embedding of the halftone of the payload. A third advantage of this method is that the extraction of the payload halftone is a very simple procedure of selecting appropriate bits from the composite halftone. No complicated image processing procedure is required in the extraction procedure. A fourth advantage of this approach is that the system implementer can configure the process so that the extraction procedure requires an appropriate key. Hence only the authorized user is able to extract the embedded information.

It is to be understood that the preferred embodiment described in this document only serve as an example of possible implementations. One who is skilled in the art can implement the halftone image embedding method using many different software or hardware implementations, or both.

### BRIEF DESCRIPTION OF THE DRAWINGS

FIG. 1 is a signal flow diagram of a halftone image embedding system where the pixels labeled “U” are those with undetermined values at that particular stage of the process.

FIG. 2 is a block diagram of a modified error diffusion system for multi-resolution halftoning.

FIG. 3 shows the use of a random number generator as a means to select pixel placement for the halftone of the payload image. The random sequence is controlled by a key.

### DETAILED DESCRIPTION OF THE PREFERRED EMBODIMENTS

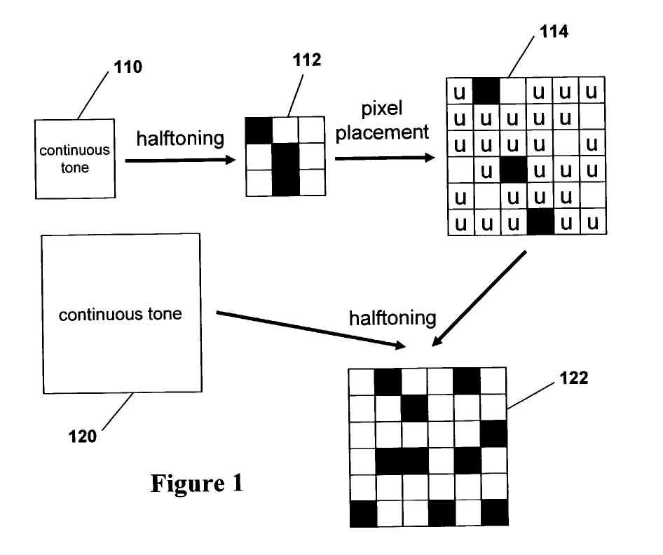

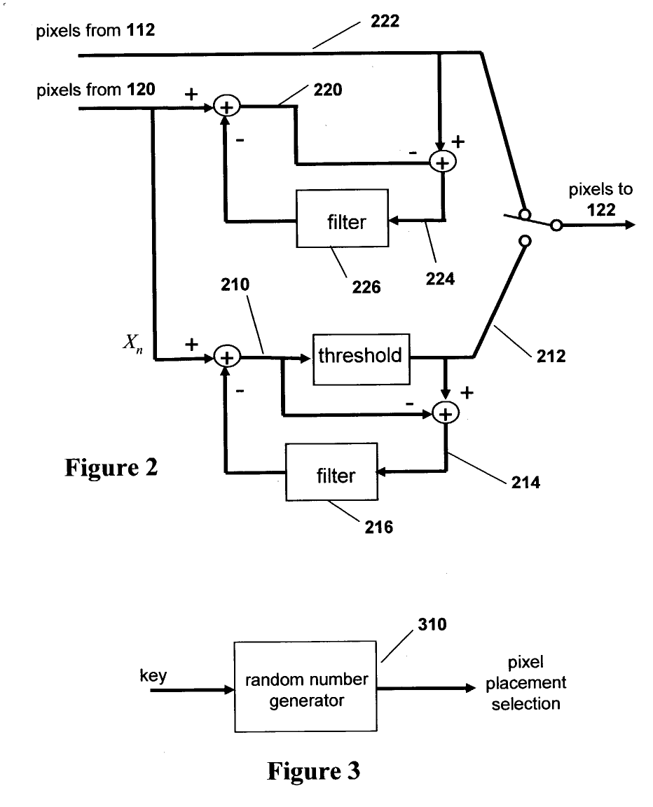

The present invention concerns a method for embedding a first binary image into a second binary image. The signal flow diagram of a preferred embodiment is shown in FIG. 1. The first binary image 112 is a halftone image of a continuous tone payload image 110. The second binary image is a halftone of a continuous tone carrier image 120. The resulting composite image 122 is a binary image. The second binary image is not explicitly shown in FIG. 1 because when the second continuous tone image 120 is halftoned, the multi-resolution halftoning algorithm takes into account the information in 114 and generates the composite image 122 directly. The composite image 122 appears visually as a halftone of the carrier image 120. When a procedure is performed to extract a subset of pixels from the composite image 122, a binary image is formed which is required to be the halftone 112 of the payload image 110. That is, a halftone of the payload image is embedded into the composite image, although the composite does not appear visually to contain information of the payload image.

The error diffusion method published by Floyd and Steinberg on pages 36-37 in the Society of Image Display International Symposium Digest of Technical Papers of 1975 can be used to generate a halftone image from a continuous tone image. In a paper published on pages 1184-1196 in IEEE Transaction on Image Processing of 1996, a halftoning method is described that can generate multi-resolution halftone images. The multi-resolution halftone image of a continuous tone image of size M by N is itself a halftone at the size M by N. The multi-resolution halftone image has the property that if it is down-sampled by a factor of s to form a binary image of size M/s by N/s, the binary image of size M/s by N/s is also a halftone of the same continuous tone image. An important property of the multi-resolution halftone image is that it contains two halftones of the same image, one at size M by N and the other one at size M/s by N/s. In the same paper, it is also shown that the procedure can be repeated recursively so that a multi-resolution halftone can contain a plurality of halftone images, all for the same continuous tone image.

The multi-resolution halftoning method can be modified for the purpose of binary image embedding. Consider a scenario where we want to embed a first halftone of an M/s pixel by N/s pixel payload continuous tone image into the halftone of an M pixel by N pixel carrier image, forming a composite halftone image. We required that the halftone of the payload be extractable from the composite image. A very important difference between the multi-resolution halftoning problem and the image embedding problem is that all the halftones in a multi-resolution halftoning problem is a halftone of the same continuous tone image, whereas the embedded halftone and the payload halftone are halftones of different images in the halftone image embedding problem.

We can use a method shown in the signal flow diagram of FIG. 1. We first generate a halftone 112 of the M/s pixel by N/s pixel payload image 110. Any halftoning method can be used for generating this halftone.

In the next step of the halftone image embedding method, we place the pixels of the M/s pixel by N/s pixel halftone 112 into an empty binary image 114 of size M pixel by N pixel. By an empty binary image, we mean that the pixel values of the binary image have not been decided yet. The image 114 in FIG. 1 illustrates this pixel placement step where the image pixels labeled “U” are pixels with values not yet determined at this stage. The other pixels with value either 0 (black) or 1 (white) corresponds to the pixels in the halftone image 112. For ease of reference, we call this image the empty composite image. Later on when the pixel values of this empty composite image are determined, this becomes the final composite image 122 or simply called the composite image. After placing the M/s by N/s pixels into the empty composite image, a fraction 1/s² of the pixels in the binary image are determined. That is, for the MN pixels in the binary composite image, a total of MN/s² pixels are determined, whereas the remaining MN(s²−1)/s² pixels are not yet decided.

In the next step of our preferred embodiment, the MN(s²−1)/s² remaining pixels are determined using a modified error diffusion procedure so that all the MN pixels in the final composite image becomes a halftone of the continuous tone carrier image. That is, we want to determine the remaining MN(s²−1)/s² pixels in 114 so that the resulting M by N binary image 122 appears visually as a halftone of the carrier image 120. In a preferred embodiment, we use a modified Floyd Steinberg error diffusion algorithm that was previously describeded in the multi-resolution halftoning paper in IEEE Transaction on Image Processing of 1996.

In the modified error diffusion algorithm, the exact same procedure as in standard Floyd Steinberg error diffusion is used when we are processing at pixel locations where the binary pixel values have not yet been determined (the pixels lableled by “U” in 114). That is, the continuous tone carrier image 120 is halftoned by the error diffusion algorithm into a halftone image 122 corresponding to the “U” pixels in 114.

Specifically, a modified input pixel value 210 is computed. This value is thresholded to produce an output halftone pixel value 212, which forms a pixel value of the halftone image 122. The binary quantizer error 214 is computed and distributed to the neighboring pixels using the filter 216. After this step, the system moves to the next pixel.

At the pixel locations where the output values have already been determined by the halftone image 112, we follow the error diffusion algorithm to calculate a modified input value 220. However, the quantization step in standard error diffusion is skipped. Instead, the binary pixel value 222 from image 112 is used and is treated in the same manner as the quantized output. That is, we compute the quantizer error 224 using the difference between the pre-determined binary pixel value 222 and the modified input 220. After this step, we distribute the quantizer error 224 to the neighboring pixels using a filter 226, and then move to the next pixel.

The modified error diffusion method works as intended for the halftone image embedding problem because of the following reasons:

The composite binary image 122 is generated using a halftoning algorithm acting on the continuous tone carrier image 120. As a result, the composite image 122 appears visually as a halftone of the carrier image 120. Although a portion of pixels were pre-determined by the halftone 112 of the payload image, the modified error diffusion procedure compensates for it by the quantization error feedback process.

The halftone 112 of the payload image can be extracted from the composite image because we had generated the halftone and then placed the pixels into the composite image 122. Therefore, the detection of extraction procedure for 112 is simply a pixel retrieval step.

An important note on the halftone image embedding method is that we place one halftone pixel of the payload image into an s by s block of the composite halftone image. In a preferred embodiment, a random sequence is used for controlling which pixel within each s by s block in the composite image will be used for hosting the halftone pixel from the payload image. The random number generator 310 in FIG. 3 emits a sample with values between the range 0 and s²⁻1 for each block, and this number is used as an index to select a pixel from an s by s block. The random sequence is controlled by a key which will be used in the extraction procedure to recover the halftone of the payload.

The way the particular image pixel is selected clearly has a significant impact on the security of the system. Here there are two different criteria of security, namely, robustness, and unauthorized extraction of the payload. Robust is measured by how well the halftone of the payload image resists changes or manipulations to the composite image. In the context of steganography or watermarking, a method is considered to be robust if the embedded signal or the watermark can resist changes better than the carrier does. That is, if the carrier is destroyed by an image manipulation step to the image faster than the payload is destroyed, then we say that the method is robust. In the binary image embedding method described in this document, any processing procedure to change the image will certainly destroy the carrier halftone faster than the payload halftone. The reason is that all the binary pixels in the composite are significant to the carrier image, whereas only one in every s² pixels is significant to the payload image.

A second security criterion is measured by how easy it is for an unauthorized user, i.e. a user who knows about the method but does not know about the key, to extract the halftone of the payload from the composite halftone. It can be shown using a probabilistic analysis that the probability of a successful brute force attack to the system is very low. As an example, consider the case where both the continuous tone carrier image and the continuous tone payload image are Gauss Markov processes with mean 0.5 and standard deviation 0.15 (relative to a normalized grayscale where 0 represents black, 1 represents white, and a fractional number represents gray). Then the probability of successfully extracting a single pixel (a single bit) is less than 0.66 or 0.50^{0.598}. Hence the ability to extract a block of N² pixels by brute force is equivalent to breaking a cryptographic system of key length 0.598N² bits. Note that the payload is a halftone image, and halftone images rely on local arrangements of dots within a local area to give impressions of graylevel. Hence it is necessary to be able to extract a sizable region of pixels before an attacker can be sure that a useful image is being extracted.

We have described a method for embedding a halftone image into another halftone image. A preferred embodiment of this invention is described in this document. The description will allow people with ordinary skill in the art to construct a similar secure binary image embedding system. Therefore the preferred embodiment is meant to be an example for illustrating the key components of the invention and should not be taken as the only embodiment that is possible with this invention.

What is claimed is:

1. A method of embedding a first halftone image into a second halftone image comprising the following steps:
i. generating said first halftone image from a first continuous tone image,
ii. placing a collection of halftone pixels from said first halftone image into said second halftone image wherein the values of the remaining pixels of said second halftone image are not yet determined,
iii. generating said remaining pixels of said second halftone image using a second continuous tone image, whereby a pixel extraction procedure can be applied to said second halftone image to retrieve said collection of halftone pixels from said first halftone image.

2. The method of claim 1 wherein said first continuous tone image is a color image.

3. The method of claim 1 wherein said first halftone image is a color halftone image.

4. The method of claim 1 wherein said second continuous tone image is a color image.

5. The method of claim 1 wherein said second halftone image is a color halftone image.

6. The method of claim 1 wherein said first halftone image is a multi-tone halftone image.

7. The method of claim 1 wherein said second halftone image is a multi-tone halftone image.

8. The method of claim 1 wherein said method of extracting said first halftone image requires the use of a key.

9. The method of claim 1 wherein said first continuous tone image is a graphics image.

10. A system for embedding a first halftone image into a second halftone image comprising
i. a first halftone means for generating said first halftone image from a first continuous tone image,
ii. a pixel placement means to place a collection of halftone pixels of said first halftone image into said second halftone image, wherein the values of the remaining pixels of said second halftone image are not yet determined,
iii. a second halftone means for generating said remaining pixels of said second halftone image from a second continuous tone image, whereby a pixel extraction means can be applied for retrieving said collection of pixels from said first halftone image.

11. The system of claim 10 wherein said first halftone means and said second halftone means are the same halftone means.

12. The system of claim 10 wherein said second halftone means is an error diffusion means.

13. The system of claim 10 wherein said first continuous tone image is a color image.

14. The system of claim 10 wherein said first halftone image is a color halftone image.

15. The system of claim 10 wherein said first halftone image is a multi-tone image.

16. The system of claim 10 wherein said second continuous tone image is a color image.

17. The system of claim 10 wherein said second halftone image is a color halftone image.

18. The system of claim 10 wherein said second halftone image is a multi-tone image.

19. The system of claim 10 wherein said first continuous tone image is a graphics image.

20. The system of claim 10 wherein said pixel extraction means requires the use of a key.
